(19) United States
(12) Patent Application Publication
(10) Pub. No.: US 2008/0072531 A1
(43) Pub. Date: Mar. 27, 2008

(54) Coated ballast pavers

(76) Inventor: Paul Oliveira, Carmel, IN (US)

Correspondence Address: Jon D. Wood;Chief I.P. Counsel, Bridgestone Americas Holding, Inc., 1200 Firestone Parkway, Akron, OH, 44317, US

(21) Appl. No.: 11/903,325

(22) Filed: Sep. 21, 2007

Related U.S. Application Data
(60) Provisional application No. 60/847,016, filed on Sep. 23, 2006.

(51) Int. Cl. E04B 7/00; B29C 39/12

(52) U.S. Cl. 52/745.06; 264/241

(57) ABSTRACT

A method is disclosed of producing ballast pavers for use in a roof system. A concrete mixture may be provided. The concrete mixture may be shaped into an uncured paver including a top surface. A reflective coating may be applied to the top surface. The uncured paver may be heated in a kiln to cure the concrete mixture. The reflective coating being substantially cured upon removal from the kiln.

This application gains the benefit of U.S. Provisional Application No. 60/847,016, filed on Sep. 23, 2006, which is incorporated herein by reference.

### FIELD OF THE INVENTION

One or more embodiments of the present invention relate to coated blocks having reflective surfaces and methods of manufacturing coated blocks for use in ballast roofing systems.

### BACKGROUND OF THE INVENTION

Many industrial and office buildings are constructed using flat or low-sloped roofs. In many cases, these roofs are covered with a plurality of abutting asphaltic or polymeric membranes. When secured together as by welding or adhesives, the membranes provide an effective waterproof barrier. While membrane roofing systems are commonly used in the construction industry, they are, however, susceptible to damage from the elements and foot traffic.

Membrane roofing systems may include ballast pavers that are placed on top of the membrane surface, often in an interlocking configuration. Ballast pavers prevent membrane uplift during high wind conditions and help maintain the integrity of seams formed when two or more adjacent membrane sheets abut one another. Also, ballast pavers protect the membrane from UV light degradation, which can compromise the physical integrity of the membrane. Finally, the ballast pavers protect the membrane from damage due to hail, wind-blown debris, walking traffic and fire.

There is also a desire to reduce costs associated with cooling building interiors. This is of particular concern in warmer climates with high sun exposures. One method of reducing heat buildup, and consequently reducing air conditioning costs, is the use of light reflective materials on roofing surfaces. For example, it has been found that the application of a reflective paint to installed ballast pavers increases solar reflectance, which in turn reduces heat buildup.

In the past, reflective roofing systems were constructed in the following manner. The polymeric membranes were first installed and then covered with ballast pavers. Next, in a separate step, paint was sprayed on-site to the upper surface of the ballast pavers. This method was effective in increasing solar reflectance levels, but added additional expense and complication to roof system construction. Further, because the ballast pavers were painted while in an uncontrolled environment, contaminates such as dirt sometimes blemished the surface or prevented full coverage. Still further, spraying paint in uncontrolled conditions resulted in uneven coverage which could lead to uneven wear and non-uniform reflectance.

Thus, there exists a need in the art for pre-coated ballast pavers which reduce construction steps and provide a more uniform coating.

### BRIEF DESCRIPTION OF THE DRAWINGS

FIG. 1 is an isometric view of a coated ballast paver made according to the methods of the present invention.

FIG. 2 is a side view of the coated ballast paver of FIG. 1.

FIG. 2A is a side view of the ballast paver disposed on a tray which is in turn disposed on a conveyor.

FIG. 3 is a flow chart showing an exemplary method of making the paver shown in FIG. 1.

FIG. 4 is schematic view of the method of making the coated ballast paver according to the present invention;

FIG. 5 is an elevated view of a building employing a ballast paver roofing system shown in cutaway;

FIG. 6 is side view of the ballast paver roofing system according to the present invention.

### DETAILED DESCRIPTION OF THE ILLUSTRATIVE EMBODIMENTS

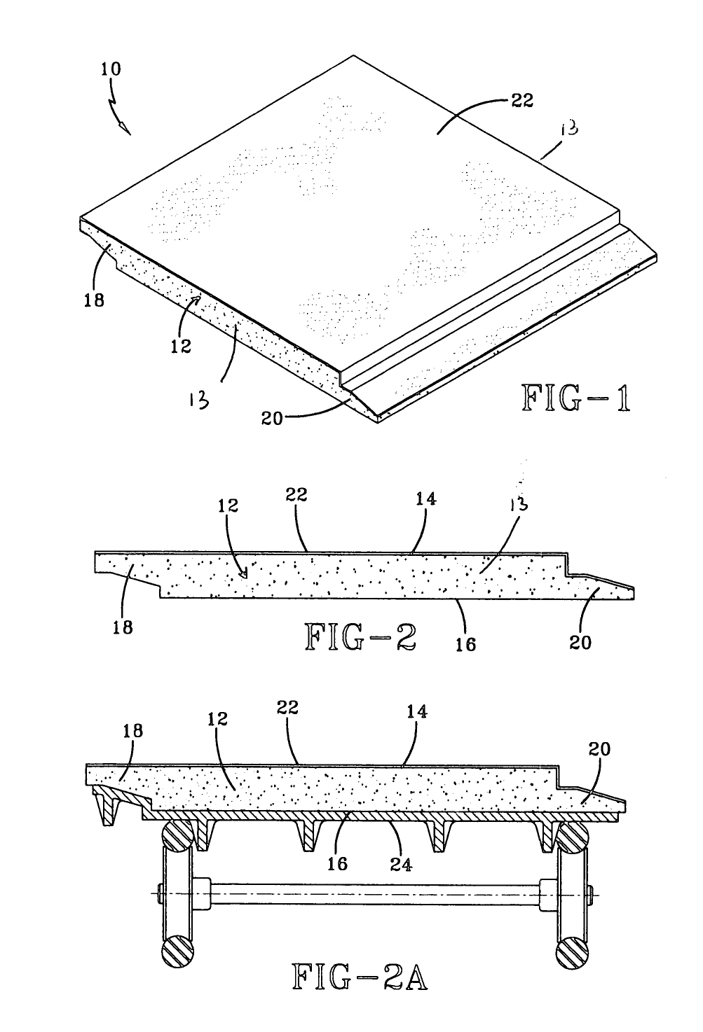

As shown in FIGS. 1 and 2, an exemplary coated ballast paver made in accordance with the method of the present invention is indicated generally by the numeral 10. Coated paver 10 may be generally described as a low-profile rectangular block having a body 12 including side surfaces 13, a top surface 14, and an opposed bottom surface 16. In certain embodiments, an upper tongue 18 may be provided that projects from one side of body 12. In these or other embodiments, a lower tongue 20 may be provided that projects from an opposed side of body 12. Upper tongue 18 and lower tongue 20 may be adapted to overlie one another when coated pavers 10 are placed in an abutting relationship. This overlying, or interlocking, configuration helps prevent paver lift-off in high wind conditions. It should, however, be appreciated that various paver configurations may be used. For example, coated pavers 10 may be any shape and may or may not include overlaying features.

Top surface 14 includes a coating 22, which may also be referred to as film 22, that is adapted to promote reflection of light or other electromagnetic radiation. In one or more embodiments, coating 22 may be provided over substantially the entire top surface 14. Coating 22 advantageously reflects light and/or radiation and thereby prevents heat buildup within the paver when exposed to sunlight. In one or more embodiments, coating 22 may be a color that is lighter than paver body 12. In these or other embodiments, coating 22 may be substantially white in color.

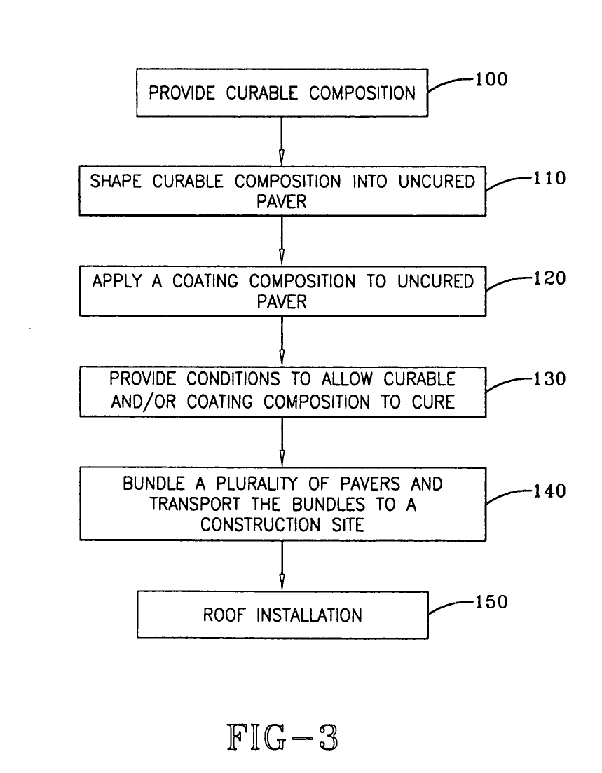

Coated paver 10 may be formed according to the method that can be described with reference to FIG. 3. The method disclosed is advantageous as compared to prior art methods in that it allows for continuous production of the coated pavers. This continuous production method, which includes applying the coating composition to the paver prior to shipment, is more efficient and may be used to produce large quantities of pavers which are ready to be installed.

In a first step 100, a curable composition is provided. The curable composition may be any composition that, when cured or otherwise solidified, provides sufficient weight and strength to withstand conditions in a roof environment. In one or more embodiments, the curable composition may be any inorganic curable composition. In one or more embodiments the curable composition may be a cement. In one or more embodiments, cements includes mixtures of lime, and/or alumina, and/or silica. Upon admixing with water, it is believed that formation of hydrates yields the hard product. In other embodiments, the curable composition may be concrete wherein an aggregate may be embedded in a matrix of mortar or cement.

In a next step 110, the curable composition is shaped into an uncured paver. At step 110, the curable composition remains wet (or green) and thus may be shaped or otherwise processed into a desired final shape. In one or more embodiments, the uncured paver may be shaped in a mold. In other embodiments, the uncured paver may be shaped on an open tray (shown in FIG. 2A). In one or more embodiments, the curable composition exhibits sufficient physical integrity to self-sustain its shape.

The uncured paver may be any shape but may include portions adapted to interlock with adjoining pavers when installed on a roof. In these or other embodiments, the uncured paver may be shaped to include portions that may overlap adjoining pavers when installed on a roof. In still other embodiments the uncured pavers may be shaped into low-profile, generally rectangular or square forms. In these and other embodiments, the uncured pavers may include at least one major top surface.

In a next step 120, a coating composition is applied to the uncured paver. In one or more embodiments, the coating may be applied on substantially the entire top surface of the uncured paver. In other embodiments, the coating may be applied to both the top and at least one side surface. In other embodiments, the coating is applied to the top and each side surface. In still other embodiments, the coating may be applied to the top major surface and to any interlocking or overlapping portions.

The coating composition may be applied by using sundry methods. For example, the coating may be sprayed onto the substrate. In other embodiments, the coating composition may be applied by rolling or brushing the coating composition onto the substrate. In other embodiments, the coating composition can be knife coated on the substrate.

In a next step 130, conditions are provided to allow the curable composition to cure. Coextensively, conditions may be provided to allow the coating composition, if it is a curable composition, to cure. In one or more embodiments the coated, uncured paver is cured in a kiln wherein the temperature is elevated above ambient temperature. In other embodiments, the coated, uncured paver may be cured in ambient conditions. In any event, after conditions for cure are provided, the resulting cured pavers include a reflective coating or film. In one or more embodiments, the pavers and associated coating advantageously exhibit sufficient strength to withstand conditions on a roof surface. Also, in one or more embodiments, the coating advantageously adheres to the paver body and resists chipping, cracking and flaking.

In one or more embodiments the coating composition is applied to the uncured paver prior to the uncured paver being placed in conditions to allow it to cure. In this embodiment the uncured paver is not placed in a kiln prior to the application of the coating composition. In this way the uncured paver and the coating composition may cure together. In another embodiment the coating composition may be applied before the paver has fully cured. In still another embodiment the coating composition may be applied before the paver has substantially cured.

In a next optional step 140, a plurality of coated pavers may be bundled and transported to a construction site. In one or more embodiments, a plurality of coated pavers may be stacked on a pallet. In one embodiment, the stacked coated pavers may be secured to the pallet with wrapped plastic film. In these or other embodiments, the stacked coated pavers may be secured using a plurality of straps. In any event, a plurality of coated pavers are grouped and transported to a construction site.

In a next optional step 150, the coated pavers may be installed on a roof. In one or more embodiments, the coated pavers may be installed as part of a roof system including a sub-structure, a waterproof membrane and the coated pavers. In such an embodiment, the waterproof membrane may be installed over the sub-structure. The waterproof membrane may comprise a plurality of waterproof sections adhered or otherwise attached to adjoining sections to form a waterproof membrane covering substantially the entire roof surface. In this or other embodiments, the coated pavers may then be placed over the waterproof membrane. In one or more embodiments, the coated pavers may cover substantially the entire waterproof membrane. In other embodiments, the coated pavers may be interlocked or overlapped to enhance wind resistance. In still other embodiments, the installed coated pavers form a substantially uniformly coated surface.

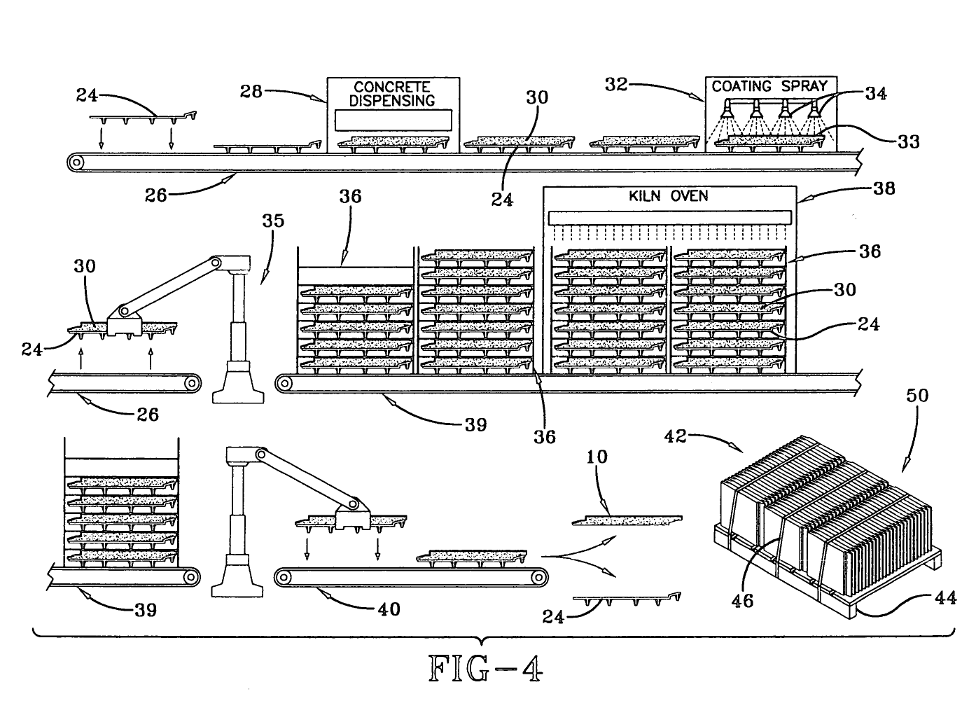

As an example of the above disclosed method, coated paver 10 may be manufactured according to a process that may be described with reference to FIG. 4. In a first step, trays 24 are placed on a conveyor system 26 that travels at a predetermined speed. Trays 24 are spaced on conveyor 26 and carried to a dispensing station 28. Dispensing station 28 supplies a predetermined amount of curable composition to each tray 24, and the curable composition is formed into a paver shape. The forming of the paver shape can be done by using a form or mold or other means in lieu of or in combination therewith. In the present embodiment, concrete is employed as the curable composition. In one or more embodiments, the mix moisture (i.e., the water content) of the cement may be from 5% to 10% by weight. In other embodiments, the mix moisture may be about 7%. In still other embodiments, the water to concrete ratio may be from about 0.35:1 to 0.45:1. In yet other embodiments, the water to concrete ratio may be about 0.41:1.

After dispensing the curable composition onto trays 24, dispensing station 28 thereafter vibrates, shapes and compresses the concrete mixture into an uncured paver 30. Uncured paver 30 advantageously may be cohesive enough to maintain its shape and while only being supported along its bottom surface by tray 24. In certain embodiments, however, uncured paver is easily deformable until cured.

Conveyor 26 carries trays 24 and corresponding uncured paver 30 from dispensing station 28 to a coating station 32. Coating station 32 sprays or otherwise coats at least the top surface of uncured paver 30 with a coating composition 33. In one or more embodiments, the wet film thickness of the coating composition 33 after application may be from 0.025 inches to 0.035 inches. In other embodiments, the wet film thickness of the coating composition after application may be about 0.030 inches. In one or more embodiments, the dry film thickness of the coating composition may be from about 0.020 inches to about 0.028 inches. In other embodiments, the dry film thickness may be about 0.024 inches.

Coating station 32 may include a spray nozzle 34 that dispenses the coating material in spray form. In other embodiments, a plurality of spray nozzles 34 may be provided in a spaced configuration to ensure thorough coverage. In still other embodiments, a spray nozzle 34 may move along with uncured pavers 30 for a predetermined distance as they are carried by conveyor 26. In any event, the uncured pavers 30 exit the coating station 32 with a coating composition 33 over at least substantially the entire top surface thereof. In other embodiments, at least one of the sides (e.g. side 13) of the uncured paver is substantially covered by coating composition 33. In certain embodiments sides 13, together with the top surface of tongue 20, are substantially covered.

After application of the coating composition 33, the uncured pavers 30 are carried by conveyor 26 from coating station 32 to a racking station 35. At racking station 35, each tray 24 along with the uncured paver 30 is transferred to a rack 36. Each rack 36 may carry a plurality of trays 24 and, once filled, are transported to a kiln 38 via a second conveyor 39.

Kiln 38 is maintained at an elevated temperature at controlled humidity levels. Curing time and kiln temperature is dependent upon the particular curable composition used for the paver as well as ambient atmospheric conditions. In one embodiment, kiln 38 may be maintained between 90 degrees and 110 degrees F. In other embodiments, the kiln may be maintained at about 100 degrees F. In one embodiment, the cure time may be between 4 and 6 hours. In other embodiments, the cure time may be about 5 hours. In certain embodiments, both the concrete mixture and coating material begin curing prior to placement into kiln 38, and may continue to cure to some degree after exiting kiln 38.

In certain embodiments, the coating composition 33 may not require heating to cure and, depending upon the coating used, may cure in ambient atmospheric conditions. In such embodiments, coating composition 33 may be applied after uncured paver 30 is cured, but while at the manufacturing facility where the paver is manufactured. Application of coating composition 33 prior to placement in kiln 38 may, however, advantageously decrease process time because the coating composition and concrete mixture cure simultaneously. For example, if the coating material is applied after curing the curable composition in kiln 38, additional time must be given to allow the coating to cure prior to stacking and bundling for shipment. This additional time is eliminated by applying coating composition 33 prior to curing within kiln 38. Accordingly, at least one technical advantage of the above disclosed process resides in the fact that the coating composition is applied to the uncured paver prior to curing the paver within the kiln.

After the prescribed time within kiln 38, the curable composition and coating composition are sufficiently cured and form a coated and cured paver 10 that is structurally self-supporting. Racks 36 may be removed from kiln 38 and the trays 24 and coated pavers 10 may be placed on a third conveyor 40. Cured pavers 10 may then be separated from trays 24. Trays 24 may thereafter be recirculated to begin the cycle again, and coated pavers 10 are transported to a shipping preparation station 42.

At shipping preparation station 42, coated pavers 10 are readied for transportation to a construction site. A predetermined number of coated pavers 10 may be stacked on pallets 44. In one or more embodiments, coated pavers 10 may be stacked with the long axis aligned vertically. In other embodiments, a plurality of coated pavers 10 may be stacked vertically on pallet 44. Pavers 10 may be restrained by straps 46, which may be bands of metal or strong fabric. Further, pallets 10 may be wrapped with a stretch wrap plastic film. These strapped, wrapped and/or palletized bundles 50 are then ready for transport to a construction site.

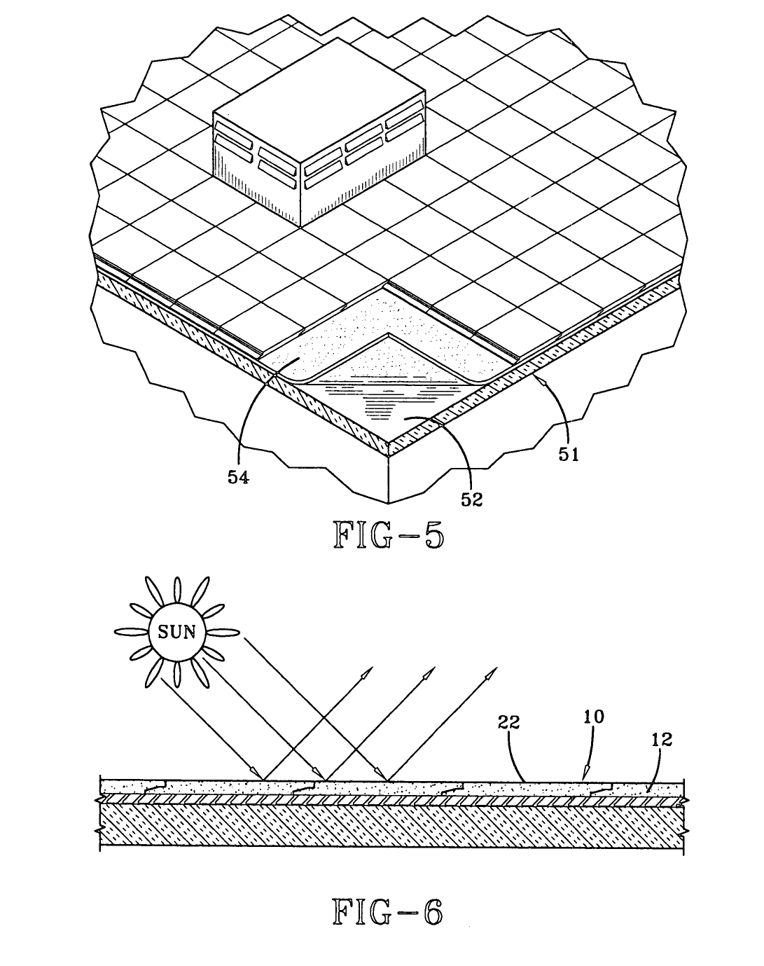

Referring now to FIGS. 5 and 6, coated pavers 10 are used in conjunction with a roofing system 51. Roofing system 51 may include a roof structure 52 that is covered by a membrane 54. Membrane 54 is typically a polymeric material, that may be in the form of sheets seamed to one another, and may include other structural features necessary for attaching the membrane 54 to the roof structure 52. Once membrane 54 is secured to the roof structure, coated pavers 10 may be positioned on the membrane 54 in a grid like arrangement. Coated pavers 10 may be disposed over substantially the entire surface of membrane 54. Further, upper tongue 20 may overlap lower tongue 18 to interlock abutting coated pavers 10. As a result, a substantially uniform, reflective surface may be formed on a building roof.

Inclusion of the reflective coating or film 22 may increase the magnitude of reflected sunlight S and consequently limit the amount of heat buildup in coated pavers 10. Other advantages are realized by practicing the above disclosed method. Notably, a greater coating uniformity is achieved as compared to prior art methods. This in turn results in greater reflectivity levels, less wasted paint, and greater durability. Further, because coating 22 is applied during manufacture, contamination is greatly controlled, resulting in better adhesion and coverage. Finally, by pre-applying coating 22, the costly and time consuming step of on-site coating is eliminated. This results in reduced cost and construction time.

The coating composition may cure, harden and/or dry into a cured coating or film that adheres to the paver body 12. In one or more embodiments, the coating composition provides a coating that is resistant to chipping, flaking or cracking due to thermal or physical stresses. In these or other embodiments, the coating composition provides a coating that absorbs relatively less sunlight than the curable composition of the paver. In one or more embodiments, the coating composition is substantially white in color.

The coating composition may be a reflective material. In these or other embodiments, the coating composition may include a reflective filler or pigment. In these or other embodiments, the coating composition may include a binder and/or a matrix. In one or more embodiments the coating composition may be a moisture curable substance. In other embodiments the coating composition may be a two-part curable substance.

The coating composition employed in one or more embodiments of the present invention may include a pigment and a binder. The pigment, which may also be referred to as a filler, may include reflective pigments. In one or more embodiments, these pigments absorb little or no infrared radiation. Examples of useful pigments include white pigments such as metal oxides. Useful metal oxides include, but are not limited to, zinc oxide and titanium dioxide. Exemplary useful pigments include those known in the art including those described in U.S. Pat. Nos. 6,989,056, 6,391,143, and 4,916,014, and U.S. Publication 2006/01059922, which are incorporated herein by reference. Other useful pigments include infrared-reflective color pigments. These pigments are known in the art and include those described in U.S. Pat. Nos. 6,815,010, 6,540,823, 5,948,845, 5,470,893, and U.S. Publication 2006/0205843, which are incorporated herein by reference.

The binder may include any film forming composition to which the pigment can be loaded and that will adhere to the substrate (i.e., the cured and/or uncured paver). In one or more embodiments, these binders form a matrix in which the pigment is dispersed. In one or more embodiments, the binder or matrix may include one or more polymers or polymer-forming constituents. For example, the matrix may include acrylics, acrylates, methacrylates, silicones, epoxies, polyureas, butyl rubber, neoprene, urethane, and polyurethanes. In one embodiment, the binder may be aliphatic polyurethane such as that sold under the tradename DECOTHANE™ SP (Liquid Plastics, Inc.).

Various modifications and alterations that do not depart from the scope and spirit of this invention will become apparent to those skilled in the art. This invention is not to be duly limited to the illustrative embodiments set forth herein.

1. A method of producing ballast pavers for use in a roof system comprising:
providing a curable composition;
forming an uncured paver from said curable composition, said uncured paver having a top surface;
applying a coating composition to said top surface; and
heating said curable composition in a kiln to form a cured paver;
wherein said coating composition includes a light reflective pigment and a binder and is substantially cured upon removal from said kiln.

2. The method according to claim 1, wherein said uncured paver is formed in a mold.

3. The method according to claim 1, wherein said uncured paver is formed on a tray

4. The method according to claim 1, wherein said coating composition includes a polyurethane.

5. The method according to claim 4, wherein said coating composition includes an aliphatic polyurethane.

6. The method according to claim 1, wherein said step of heating said uncured paver further includes heating said uncured paver from about four hours to about six hours.

7. The method according to claim 6, wherein said step of heating said uncured paver further includes the step of heating said uncured paver about five hours.

8. The method according to claim 1, further including the steps of providing a conveyor that carries said uncured paver and applying said reflective coating while said uncured paver is carried by said conveyor.

9. The method according to claim 1, wherein said step of applying said coating composition further includes the steps of providing a spray nozzle and spraying a coating composition through said nozzle.

10. The method according to claim 9, wherein said step of applying said coating composition further includes the steps of providing a plurality of spaced spray nozzles and spraying said coating composition through said nozzles.

11. The method according to claim 9, wherein said step of applying said coating composition further includes providing a spray nozzle, spraying a reflective material through said nozzle, and moving said spray nozzle along with said uncured paver for a predetermined distance as said uncured paver is carried by said conveyor.

12. The method according to claim 1, wherein said coating composition is applied to said top surface prior to heating said uncured paver in said kiln.

13. The method according to claim 1, wherein said coating composition is applied to said top surface prior to substantial curing of said paver.

14. A method of installing a heat resistant roofing system on a building comprising;
coating a top surface of a plurality of ballast pavers with a reflective coating composition;
applying a membrane to a roof; and
positioning said ballast pavers on said membrane;
wherein said step of coating said top surface is performed prior to shipment of said ballast pavers to said building.

15. The method according to claim 14, wherein said coating composition includes polyurethane.

16. The method according to claim 15, wherein said coating composition includes aliphatic polyurethane.

17. The method according to claim 14, wherein said ballast paver includes a body portion consisting of a concrete mixture.

18. A method of producing ballast pavers comprising;
providing a tray;
dispensing a concrete mixture on said tray;
shaping said concrete mixture into a uncured paver;
applying a reflective coating composition to a surface of said uncured paver; and
heating said uncured paver and said reflective coating composition in a kiln.
